(19) United States
(12) Patent Application Publication
(10) Pub. No.: US 2009/0073259 A1
(43) Pub. Date: Mar. 19, 2009

(54) IMAGING SYSTEM AND METHOD

(75) Inventors: Carlos HERNANDEZ, Cambridge (GB); Gabriel Julian BROSTOW, Cambridge (GB); Roberto Cipolla, Cambridge (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/233,967

(22) Filed: Sep. 19, 2008

(30) Foreign Application Priority Data
Sep. 19, 2007 (GB) 0718316.3

(51) Int. Cl. H04N 13/00

(52) U.S. Cl. 348/48; 348/E13.021

(57) ABSTRACT

An imaging system for imaging a moving three dimensional object, the system comprising:
at least three light sources, irradiating the object from three different angles,
a video camera provided to collect radiation from said three light sources which has been reflected from said object; and
an image processor,
wherein each light source emits radiation of a different frequency and said image processor is configured to distinguish between the reflected signal from the three different light sources.

The present invention is concerned with the field of imaging systems which may be used to collect and display data for production of 3D images. The present invention may also be used to generate data for 2D and 3D animation of complex objects.

The field of 3D image production has largely been hampered by the time which it takes to take the data to produce a 3D film. Previously, 3D films have generally been perceived as a novelty as opposed to a serious recording format. Now, 3D image generation is seen as being an important tool in the production of CG images.

One established method of producing 3D image data has been photometric stereo (see for example R Woodham “photometric method for determining surface orientation from multiple images” Optical Eng. Number 1, pages 139-144 1980) where photographs are taken of an object from different illumination directions. A single photograph is taken for each illumination direction. Thus, this is not a technique which can be used for capturing video of a moving object in real time.

The present invention addresses the above problem and in a first aspect provides an imaging system for imaging a moving three dimensional object, the system comprising:
at least three light sources, irradiating the object from three different angles;
a video camera provided to collect radiation from said three light sources which has been reflected from said object; and
an image processor configured to generate a depth map of the three dimensional object,
wherein each light source emits radiation of a different frequency and said image processor is configured to distinguish between the reflected signal from the three different light sources.

A, Petrov “Light Color and Shape” Cognitive Processes and their Simulation, pages 350-358, 1987 discuss the use of colour for computing surface normals.

However, there has been no realisation that colour could be used to address the issue of recording 3D video in real time.

Further, the technique can be applied to recording data for complex objects such as cloth, clothing, knitted or woven objects, sheets etc.

When recording data from a moving object self shadowing will occur and this will affect data. Therefore, preferably, said processor is configured to determine the position of shadows arising as said object moves. The position of shadows is determined by locating sharp changes in the intensity of the signal measured from each of said light sources.

In a preferred embodiment, the processor is configured to determine the position of shadows before determining the position of surface normals for said object.

In a preferred embodiment, the apparatus further comprises a memory configured to store calibration data, said calibration data comprising data from a sample with a same surface characteristic as the object stored with information indicating the orientation of the surface of the sample. The processor may then be configured to determine the depth map for the object from the collected radiation using the calibration data.

The above may be achieved by using a calibration board and a mounting unit configured to mount said calibration board, said calibration board having a part of its surface with the same surface characteristics as the object and said mounting unit to mount comprising a determining unit configured to determine the orientation of the surface of the calibration board.

Although the data gathering apparatus can stand alone, it may be incorporated in part of a 3D image generation apparatus further comprising a displaying unit configured to display a three dimensional moving image from said depth map.

The system may also be used in 2D or 3D animation where the system comprises a moving unit configured to move said generated depth map.

The system may also further comprise an applying unit configured to apply pattern to the depth map, the applying unit configured to form a 3D template of the object from a frame of the depth map and determine the position of the pattern on said object of said frame and to deform said template with said pattern to match subsequent frames. The template may be deformed using a constraint that the deformations of the template must be compatible with the frame to frame optical flow of the original captured data. Preferably the template is deformed using the further constraint that the deformations be as rigid as the data will allow.

In a second aspect, the present invention provides a method for imaging a moving three dimensional object, the method comprising:
irradiating said object with at least three light sources from three different angles, wherein each light source emits radiation at a different frequency;
using a video camera to collect radiation from said three light sources which has been reflected from said object;
distinguishing between the reflected signal from the three different light sources; and
generating a depth map of the three dimensional object from the output of the video camera.

The method may be applied to animating cloth or other flexible materials.

The present invention will now be described with reference to the following non-limiting embodiments in which:

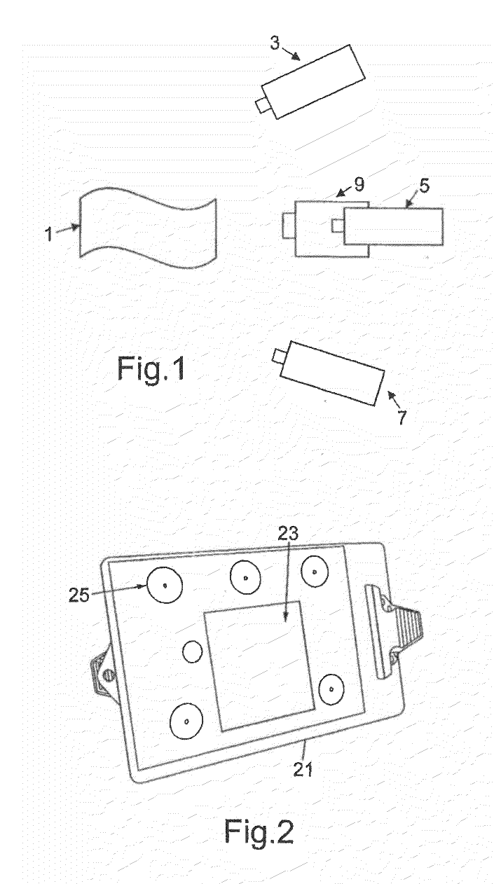

FIG. 1 is a schematic of an apparatus in accordance with an embodiment of the present invention;

FIG. 2 is a calibration board used to calibrate the apparatus of the present invention;

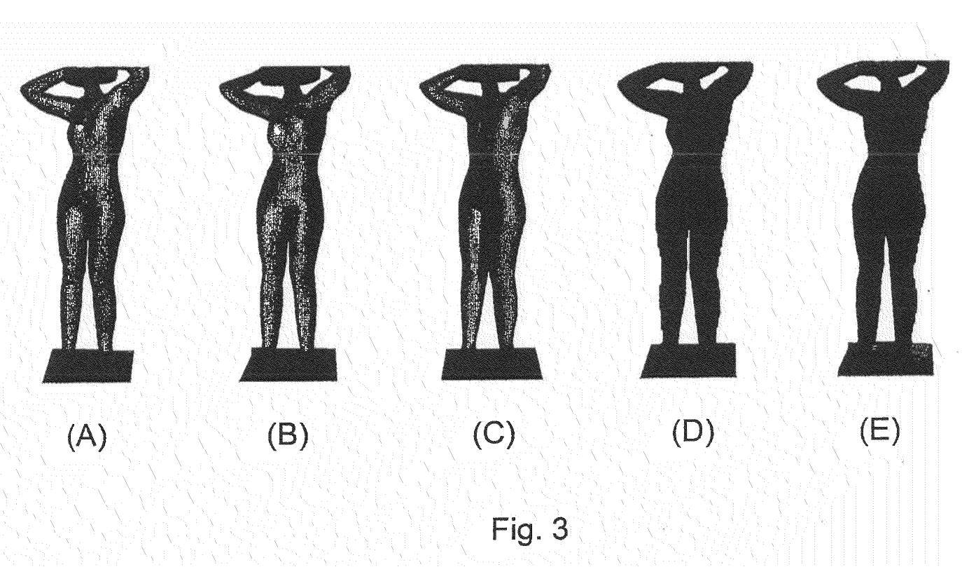

FIGS. 3A, 3B and 3C are a frame from a video of a moving object which is collected using a video camera and three different colour light sources illuminating the object from different positions, FIG. 3A shows the frame with the component of the image collected from the first light source, FIG. 3B shows the frame with the component of the image collected from the second light source; and FIG. 3C shows the frame with the component of the image collected from the third light source, FIG. 3D shows the edges of the image determined by a Laplacian filter and FIG. 3E shows where the lights cast their shadows;

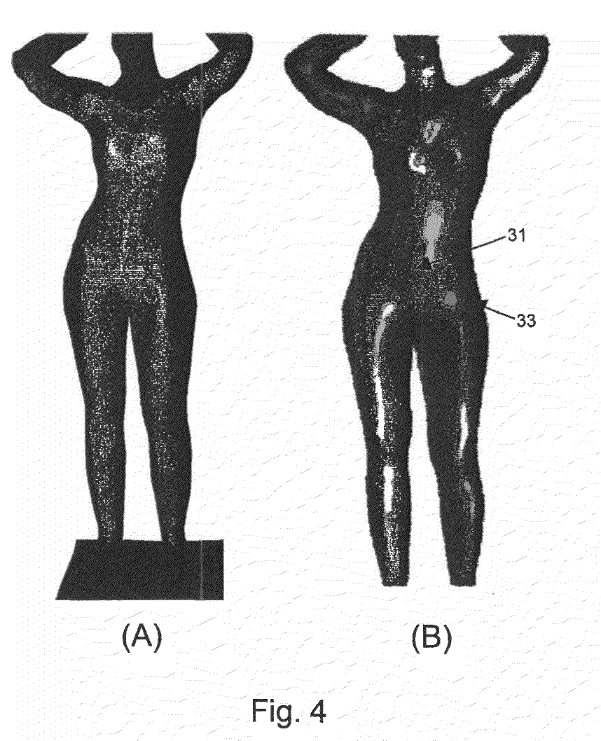

FIG. 4A is an image of the model shown in FIG. 3 illuminated by all three lights and

FIG. 4B shows the generated image;

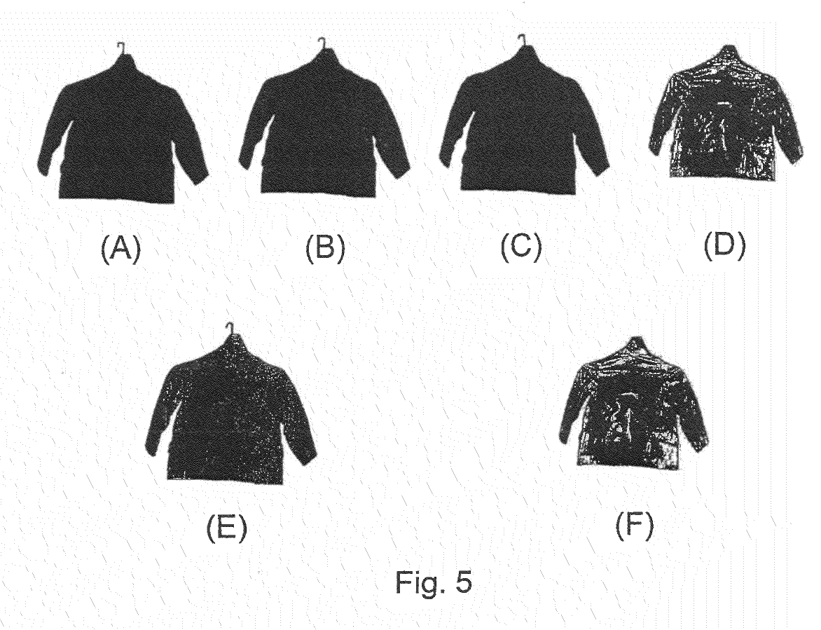

FIGS. 5A, 5B and 5C are three frames of a jacket captured using the prior art technique of photometric stereo where each frame A, B and C is individually captured using illumination from a different illumination direction, FIG. 5D is a 3D image generated from the data of FIGS. 5A, B and C, FIG. 5D is a frame a from each of the light sources respectively described in the apparatus of FIG. 1, FIG. 5E is a frame captured by the apparatus of FIG. 1 and FIG. 5F is a 3D image generated from the frame of FIG. 5E;

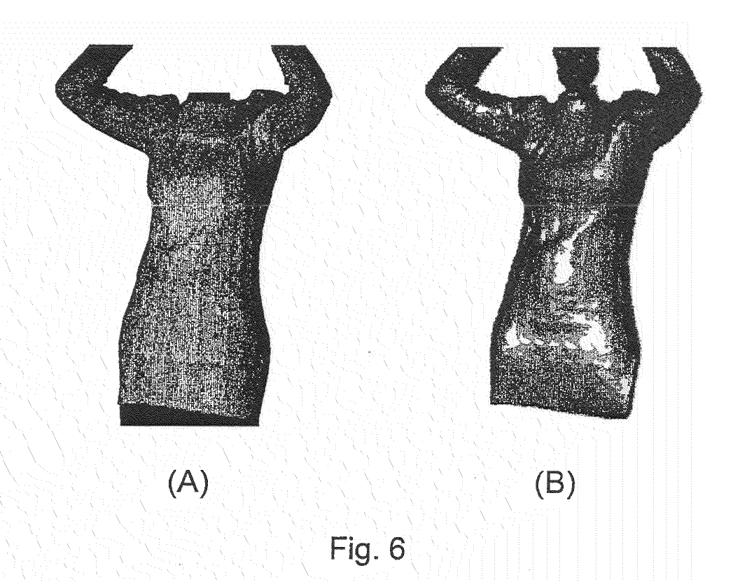

FIG. 6a is a frame from a video of a moving object wearing a jumper with texture being collected using a video camera and three different colour light sources and FIG. 6b is a 3D image generated from the data collected from the object shown in FIG. 6a;

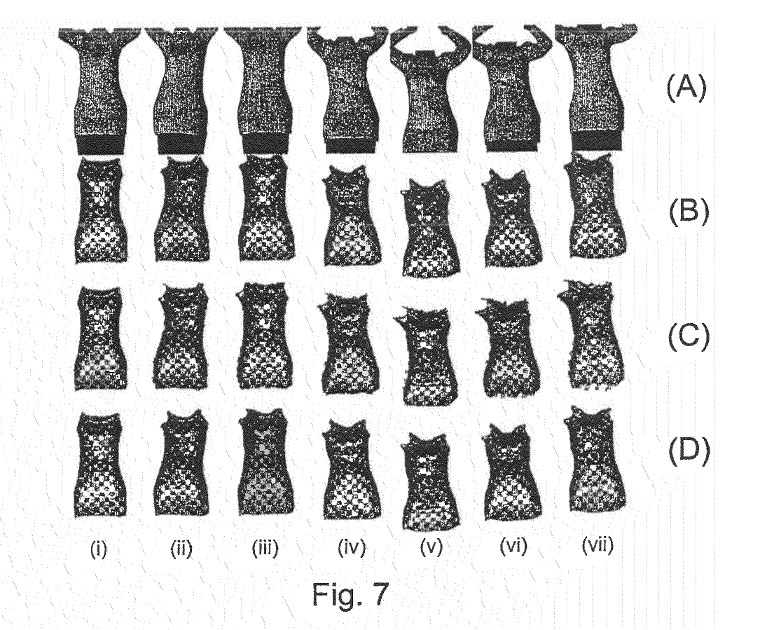

FIG. 7A is a series of frames of a dancer, FIG. 7B is a series of frames of a 3D image generated of the dance of FIG. 7A with a colour pattern superimposed on the jumper of the dancer, FIG. 7C is a series of frames of the dancer of FIG. 7A showing an enhanced method of superimposing a colour image onto the dancer where the pattern uses a registration scheme with advective optical flow and FIG. 7D is a series of frames of the dancer of FIG. 7A using the advective optical flow of FIG. 7C with a rigidity constraint;

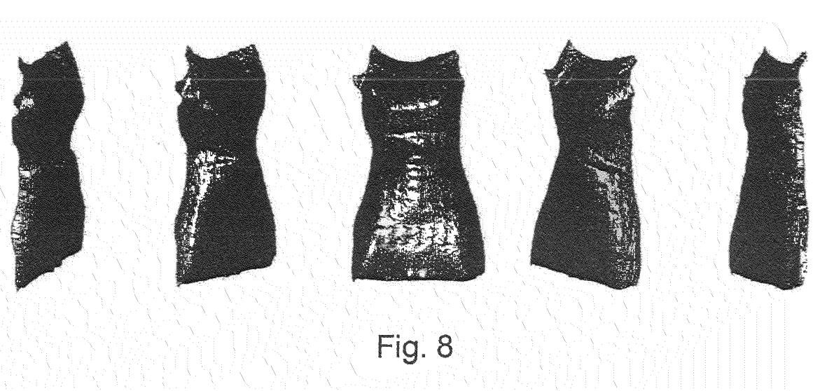

FIG. 8 shows a 3D image viewed from 5 different angles; and

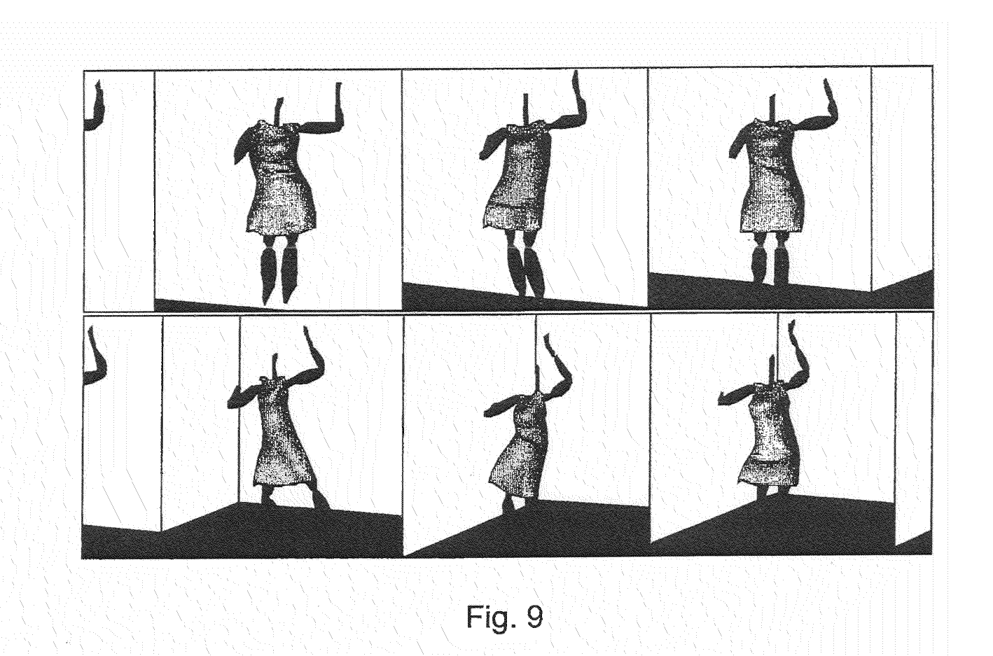

FIG. 9 shows an articulated skeleton with a dress modelled in accordance with an embodiment of the present invention.

FIG. 1 is a schematic of a system in accordance with an embodiment of the present invention used to image object 1. The object is illuminated by three different light sources 3, 5 and 7.

In this particular example, first light source 3 is a source of red (R) light, second light source 5 is a source of green (G) light and third light source 7 is a source of blue (B) light. However other frequencies may be used. It is also possible to use non-visible radiation such as UV or infrared.

In this embodiment, the system is either provided indoors or outside in the dark to minimise background radiation affecting the data. The three lights 3, 5 and 7 are arranged laterally around the object 1 and are vertically positioned at levels between floor level to the height of the object 1. The lights are directed towards the object 1.

The angular separation between the three light sources 3, 5 and 7 is approximately 30 degrees in the plane of rotation about the object 1. Greater angular separation can make orientation dependent colour changes more apparent. However, if the light sources are too far apart, concave shapes in the object 1 are more difficult to distinguish since shadows cast by such shapes will extend over larger portions of the object making data analysis more difficult. In a preferred arrangement each part of the object 1 is illuminated by all three light sources 3, 5 and 7.

Camera 9 which is positioned vertically below second light source 5 is used to record the object as it moves while being illuminated by the three lights 3, 5 and 7.

To calibrate the system, a calibration board of the type shown in FIG. 2 may be used. The calibration board 21 comprises a square of cloth 23 and a pattern of circles 25. Movement of the board 21 allows the homography between the camera 9 and the light sources 3, 5 and 7 to be calculated. Calculating the homography means calculating the light source directions relative to the camera. Once this has been done, zoom and focus can change during filming as these do not affect the colours or light directions. The cloth 23 also allows the association between colour and orientation to be measured.

To determine the shape, it is first necessary to determine the orientation of the normals to the surface for all points on the surface of the object to be imaged. This embodiment assumes that the three lights sources 3, 5 and 7 induce a colour cue on every surface point which is dependent on the orientation of that surface point.

Thus, there is a one-to-one mapping M between the surface colour I and the orientation n:

I=M(n) or n=M⁻¹(I)

To determine M, photometric-stereo techniques assume that the surface is a Lambertian surface and that the camera sensor response is linear.

$$I = {[ {I}_{R} {I}_{G} {I}_{B} ]}^{T} n + ( \begin{matrix}{b}_{R} \\ {b}_{G} \\ {b}_{B}\end{matrix} ) = [ {L}^{T} b ] ( \begin{matrix}n \\ 1\end{matrix} )$$

Where I is the RGB colour observed on the image, b is a constant vector that accounts for ambient light, n is the unit normal at the surface location and L is a 3×3 matrix where every column represents a 3D vector directed towards the light source and scaled by the light source intensity times the object albedo. The object albedo is the ratio of the reflected to incident light.

To simplify this example, it is assumed that the ratios of the colors are constant i.e. the ration between R/B and B/G should be the same for each pixel in the image. This will allow the mapping between colours and surface orientation to be determined by estimating the 3×4 matrix [L^{T}b] up to a scale factor.

For many practical situations, it will be more difficult to calculate the mapping since the camera response is non-linear and the surface will not be a Lambertian reflector. However, it is possible to use a calibration tool of the type shown in FIG. 2 to measure the mapping. If the surface material of the object which is to be imaged is placed in square 23 of the calibration board 21, it is possible to measure an image signal for each possible surface normal as part of a calibration sequence. Thus, the correspondence between surface normals nᵢ and material colour values Iᵢ can be determined even for non-linear conditions and surfaces which does not have perfectly Lambertian reflectance characteristics.

The results from the initial calibration routine where an image is captured for various known orientations of the board does not need to be performed for every possible board orientation as nearest neighbour interpolation can be used to determine suitable data for all orientations. It is possible to capture data from just 4 orientations in order to provide calibration data for a 3×4 matrix. Good calibration data is achieved from around 50 orientations. However, since calibration data is easily collected it is possibly to obtain data from thousands of orientations.

Although the technique of using the calibration board can be used to determine complex mappings for non-Lambertian reflectors and cameras with non-linear response functions, it is still necessary to assume that the object albedo has constant chromaticity. If this is not assumed, the mapping M is non invertible and there will be several valid surface orientations for the same surface colour.

The object may also shadow itself during filming. FIG. 3A is an image of a dancer wearing a spandex bodysuit taking using the system of FIG. 1. FIG. 3A shows the image data from the red light source, FIG. 3B from the green light source and FIG. 3C from the blue light source. In this particular example, the red light source is to the dancer's right hand side, the green light source in front of the dancer and the blue light source is to the dancer's left hand side. In the pose shown, the dancer turns to her right. The shadow caused by her left leg on her right leg is more pronounced in FIG. 3C.

In the absence of a shadow, the reflected illumination from one channel, i.e. either red, green or blue would be expected to vary smoothly. A sharp variation indicates the presence of an edge, these edges are determined for each channel by using a Laplace filter. The results from this analysis which is carried out per channel is shown in FIG. 3D.

The pixels which are determined to be edge pixels are then further analysed to determine gradient orientation. The pixels are analysed along each of the either cardinal directions (i.e. north, south, east, west, north-west, south-west, north-east, south-east). Pixels whose gradient magnitude falls below a threshold τ are rejected. Adjoining pixels whose gradient directions agree are grouped into connected components.

The algorithm could also be used to determine the difference between boundary edges of the object and shadows. This is shown in FIG. 3E. In FIG. 3E, the boundary edges of the object occur where all three channels (RGB) show a sharp change in the intensity of the reflected signal.

From the above a look up shadow mask can be determined.

The surface may then be reconstructed by first determining the position of the shadows using the above technique and then estimating the normal for all pixels where there is a good signal from all three lights, i.e. there is no shadow. The normal is estimated as described above.

If the signal from only two lights can be used, then the data can still be processed but constant albedo must be presumed, i.e. constant chromaticity and constant luminance.

Once the 2D grid of surface normals is produced, each frame of normals is integrated using a 2D Poisson solver or the like for example, a Successive OverRelaxation solver (SOR) is used to produce a video of depth maps or surface mesh for each frame.

The generation of the surface mesh for each frame is subject to the boundary conditions of the shadow mark which is used as the boundary conditions for the Poisson solver. Frame to frame coherency of silhouettes is also taken as a boundary condition.

To verify the accuracy of the technique a MacBeth colour chart was used. The chart was illuminated with each of the coloured lights in turn.

It was found that the technique compensated for impurities in the colours of the lights e.g. the red light produced small amounts of blue and green light in addition to the red light. Also, the technique compensated for colour balance functions that are often used in modern video cameras.

FIG. 4a shows the dancer of FIG. 3 illuminated by all three RGB lights and FIG. 4b shows the reconstructed image. The dancer is wearing spandex which is a non perfectly Lambertian material. Details can be seen on the reconstructions such as the seam 31 and the hip bones 33 of the dancer. Thus a moving image of the type shown in FIG. 4B can be produced in real time from the data taken in FIG. 4A.

FIG. 5 is a comparison of the results between a conventional method and those of an embodiment of the present invention.

FIGS. 5A, 5B and 5C show three frames captured individually using the technique of photometric stereo. In photometric stereo, individual images are captured using a digital still camera. The data from the three images is then processed to form 3D image 3D according to a known method (see for example, R Woodham “photometric method for determining surface orientation from multiple images” Optical Eng. Number 1, pages 139-144 1980).

This can be compared with the method of the present invention as shown in FIG. 1 where three lights of different colours are used to illuminate the jacket as shown in FIG. 5E. The 3D image generated using the apparatus of FIG. 1 is shown in FIG. 5F.

Although the images of FIGS. 5D and 5F are similar, only the image of FIG. 6F can be used as a frame in a real-time 3D video construction. Previously we have discussed issues which may affect the quality of the 3D image, namely impurity of the monochromatic sources and colour balance functions provided in the camera itself. However, it was found that the error between the 3D image of FIG. 5D and that of FIG. 5F was only 1.4% this error was calculated using the bounding box diagonal.

FIG. 6 shows the reconstruction of a complicated textile material. FIG. 6A shows a model wearing a jumper with a complicated texture pattern. The model is illuminated using three lights sources as explained with reference to FIG. 1.

FIG. 6B shows the image generated as explained with reference to FIG. 3 for the model of FIG. 6A. The complicated surface texture of the knit of the jumper can be clearly seen in the generated image.

However, clothing will often have a pattern which is provided by colour on the surface wither in addition to or instead of texture.

FIG. 7A is a series of images of a dancing model ((i)-(vii)) taken using the apparatus described with reference to FIG. 1. The dancing model is wearing the same jumper which was reconstructed in FIGS. 6A and 6B. However, FIG. 7 will be used to illustrate that a method in accordance with an embodiment can be used to show how a colour pattern can be applied to cloth.

In the results shown in FIG. 7 a colour video camera was used with a resolution of 1280×720. Computation times were of the order of 20 seconds per frame for the depth map recovery and a further 20 seconds per frame for the superposition of the pattern. The computations were carried out using a 2.8 GHz Pentium 4 processor with 2 Gb of RAM.

FIG. 7B shows a series of 3D images generated of the dancer of FIG. 7A. Each image of FIG. 7B corresponds to the frame ((i)-(vii)) of FIG. 7A shown directly above. Frames (i) to (viii) are selected frames from a sequence of frames:

Frame (i)—Frame no. 0

Frame (ii)—Frame no. 250

Frame (iii)—Frame no. 340

Frame (iv)—Frame no. 380

Frame (v)—Frame no. 427

Frame (vi)—Frame no. 463

Frame (vii)—Frame no. 508

In the first method of superimposing a colour pattern onto the dancer, the colour image which is the words ICCV 07 and green and yellow flag are generated using the depth map data as described above. This can be seen to work well for frames (i) to (iii), however, in frame (iv) both the flag and the pattern are staying on the same vertical level even though the dancer is moving down. In frame (iv), the flag is seem to deform well with the dancer's jumper. However, the pattern is staying on the same vertical lever even through the dancer is moving down. Thus the pattern appears to be moving upwards relative to the dancer's jumper. This problem continues in frames (v) to (vii).

FIG. 7C illustrates the results of an enhanced method for superposing a pattern onto the jumper. Here, the first depth map of the sequence (i) is used as a template which is deformed to match all subsequent depth maps.

This is done by letting z^{k}(u,v) be the depth map at frame t. A deformable template is set which corresponds to the depth map at frame 0, the template is a triangular mesh with vertices:

x⁰ᵢ=(uᵢ⁰,vᵢ⁰,z⁰(uᵢ⁰,vᵢ⁰)) i=1 . . . N

and a set of edges ε.

At frame t, the mesh is deformed to fit the tₜₕ depth map by applying a translation Tᵢ^{t} to each vertex xᵢ so the i^{th} vertex at frame t moves to xᵢ⁰+Tᵢ^{t}

The images generated in FIG. 7C were generated using the constraint that the deformations of the template must be compatible with the frame-to-frame 2D optical flow of the original video sequence.

Frame-to-frame optical flow is first computer using a video of normal maps. A standard optical flow algorithm is then used (see for example M Black and P Anadan “The robust estimation of multiple motions: parametric and piecewise smooth flow fields” Computer Vision and Image Understanding, volume 63(1), pages 75 to 104, January 1996) for which every pixel location (u,v) in frame t predicts the displacement d^{t}(u,v) of that pixel in frame t+1. Let (u^{t},v^{t}) denote the position in frame t of a pixel which in frame 0 was at (u⁰, v⁰). (u^{t},v^{t}) can be estimated by advecting d^{t}(u,v) using:

(u^{j},v^{j})=(u^{j-1},v^{j-1})+d^{j-1}(u^{j-1},v^{j-1}) where j=1 . . . t

If there was no error in the optical flow and the template from frame zero was deformed to match frame t, then vertex xᵢ⁰ in frame t is displaced to point:

yᵢ^{t}=(uᵢ^{t},vᵢ^{t},z^{t}(uᵢ^{t},vᵢ^{t}))

This constraint can be formulated as an energy term comprising the sum of squared differences between the displaced vertex locations xᵢ⁰+Tₜ^{t} and the positions predicted by the advected optical flow yᵢ^{t} at frame t:

$${E}_{D} ( {T}_{1}^{t} , … , {T}_{N}^{t} ) = {\sum }_{i = 1}^{N} {‖ {x}_{i}^{0} + {T}_{i}^{t} - {y}_{i}^{t} ‖}^{2}$$

The results of the above process are seen in FIG. 7C. Here it can be seen that the pattern deforms with the jumper and also remains at the same position relative to the jumper. However, looking at the top of the jumper it can be seen that stretching and other geometric artefacts are starting to occur. This is seen from frame (ii) and by frame (viii) the whole top of the jumper is seen to be distorted. These artefacts are caused by errors in the optical flow due to image noise or occlusions.

To address this issue a further constraint is added to bring rigidity into the picture. To regularise the deformation of the template mesh, translations applied to nearby vertices need to be kept as similar as possible. This is achieved by adding energy term E_{R}:

$${E}_{R} ( {T}_{1}^{t} , … , {T}_{N}^{t} ) = {\sum }_{( l , j ) ∈ ɛ} {‖ {T}_{i}^{t} - {T}_{j}^{t} ‖}^{2}$$

The above two terms are then combined:

E_{TOT}(T₁^{t}, . . . , T_{N}^{t})=αE_{D}+(1−α)E_{R}

which is optimised with respect to T₁^{t}, . . . , T_{N}^{t} for every frame t. For optimisation an iterated scheme is used where Tᵢ^{t} with the optimal translation \hat{T}ᵢ^{t} given that every other translation is constant. This leads to:

$$\hat{{T}_{i}^{t}} = α ( {y}_{l}^{t} - {x}_{i} ) + ( 1 - α ) \frac{1}{N ( i )} {\sum }_{j ∈ N ( i )} {T}_{j}^{t}$$

Where N(i) is the set of neighbours of vertex i and α is a parameter indicating the degree of rigidity of the mesh. The results of this calculation are shown in FIG. 7D where the pattern can be seen to move and deform with the dancer's jumper and to artefacts are seen in the jumper as the frames progress. In the experiment shown the pattern tracked the jumper for more than 500 frames.

FIG. 8 shows 5 views from different angles of the 3D image of the dancer of FIGS. 6 and 7 (frame (iv) of FIG. 7). The images are shown without the colour pattern. The details of the jumper can be seen in all five views. The mesh contains approximately 180,000 vertices.

The data described with reference to FIGS. 6, 7 and 8 shows how an embodiment of the present invention can be used for modelling cloth and cloth with both complex texture patterns and complex colour patterns.

FIG. 9 shows how an embodiment of the present invention can be used for modelling cloth for animation. In FIG. 9, the moving mesh of FIGS. 6 and 7 is attached to an articulated skeleton.

Skinning algorithms are well known in the art of computer animation. To generate the character of FIG. 9a smooth skinning algorithm is used in which each vertex vₖ is attached to one of more skeleton joints and a link to each joint j is weighted by w_{i,k}. The weights control how much the movement of each joint affects the transformation of a vertex:

$${v}_{k}^{t} = {\sum }_{i} {w}_{i , k} {S}_{i}^{t - 1} {v}_{k}^{t - 1} , {\sum }_{i} {w}_{i , k} = 1$$

The matrix Sᵢ^{t} represents the transformation from the joint's local space to world space at time instant t.

The mesh was attached to the skeleton by first aligning a depth pattern of the fixed dress with a fixed skeleton and for each mesh vertex a set of nearest neighbours on the skeleton. The weights are set inversely proportional to these distances. The skeleton is then animated using publicly available mocap data (Carnegie-mellon mocap database http://nocap.cs.cmu.edu). The mesh is animated by playing back one of the captured cloth sequences.

1. An imaging system for imaging a moving three dimensional object, the system comprising:
at least three light sources, irradiating the object from three different angles;
a video camera provided to collect radiation from said three light sources which has been reflected from said object; and
an image processor configured to generate a depth map of the three dimensional object,
wherein each light source emits radiation of a different frequency and said image processor is configured to distinguish between the reflected signal from the three different light sources.

2. An imaging system according to claim 1, further comprising a memory configured to store calibration data, said calibration data comprising data from a sample with a same surface characteristic as the object stored with information indicating the orientation of the surface of the sample.

3. An imaging system according to claim 2, wherein said processor is configured to determine a plurality of surface normals for the object from the collected radiation using the calibration data.

4. An imaging system according to claim 2, further comprising a calibration board and a mounting unit configured to mount said calibration board, said calibration board having a part of its surface with the same surface characteristics as the object and said mounting unit to mount comprising a determining unit to determine the orientation of the surface of the calibration board.

5. An imaging system according to claim 1, wherein said processor is configured to determine the position of shadows arising as said object moves.

6. An imaging system according to claim 5, wherein the position of shadows is determined by locating sharp changes in the intensity of the signal measured from each of said light sources.

7. An imaging system according to claim 5, wherein said processor is configured to determine the position of shadows before determining the position of surface normals for said object.

8. An imaging system according to claim 1, wherein said object comprises a non-rigid material.

9. An imaging system according to claim 1, wherein said object is cloth.

10. A generating system for generating three dimensional images comprising an imaging system according to claim 1 and a displaying unit configured to display a three dimensional moving image from said depth map.

11. A generating system for generating animation data, said system comprising an imaging system according to claim 1 and a moving unit configured to move said generated depth map.

12. A generating system according to claim 10, further comprising an applying unit configured to apply pattern to the depth map, the applying unit configured to form a 3D template of the object from a frame of the depth map and determine the position of the pattern on said object of said frame and to deform said template with said pattern to match subsequent frames.

13. A generating system according to claim 12, wherein said template is deformed using a constraint that the deformations of the template must be compatible with the frame to frame optical flow of the original captured data.

14. A generating system according to claim 13, wherein the template is deformed using the further constraint that the deformations be as rigid as the data will allow.

15. A method for imaging a moving three dimensional object, the method comprising:
irradiating said object with at least three light sources from three different angles, wherein each light source emits radiation of a different frequency;
using a video camera to collect radiation from said three light sources which has been reflected from said object;
distinguishing between the reflected signal from the three different light sources; and
generating a depth map of the three dimensional object from the output of the video camera.

16. A method according to claim 15, further comprising storing calibration data, said calibration data comprising data from a sample with a same surface characteristic as the object stored with information indicating the orientation of the surface of the sample.

17. A method according to claim 15, further comprising determining the position of shadows arising as said object moves.

18. A method according to claim 17, wherein the position of shadows is determined by locating sharp changes in the intensity of the signal measured from each of said light sources.

19. A method according to claim 17, wherein the position of shadows is determined before determining the position of surface normals for said object.

20. A method of animating cloth, the method comprising:
imaging cloth according to the method of claim 15 and animating said generated depth map.
